(19) United States
(12) Patent Application Publication
(10) Pub. No.: US 2006/0212349 A1
(43) Pub. Date: Sep. 21, 2006

(54) Method and system for delivering targeted banner electronic communications

(76) Inventor: Shane Brady, Stilwell, KS (US)

Correspondence Address: LATHROP & GAGE LC, 2345 GRAND AVENUE, SUITE 2800, KANSAS CITY, MO, 64108, US

(21) Appl. No.: 11/361,480

(22) Filed: Feb. 24, 2006

Related U.S. Application Data
(60) Provisional application No. 60/655,811, filed on Feb. 24, 2005.

(51) Int. Cl. G06Q 30/00

(52) U.S. Cl. 705/14

(57) ABSTRACT

A system provides banners to the web sites or web pages of publishers, of a publisher network, that are being browsed by users. The banners provided to the web sites or web pages are banners that are of particular relevance to the browsing user, based on the past browsing behavior of the user.

### RELATED APPLICATION

This application is related to and claims priority from U.S. Provisional Patent Application Ser. No. 60/655,811, entitled: Method And System For Delivering Behaviorally Targeted And Contextually Targeted Banner Advertisements Over A Network Based On Keywords, filed on Feb. 24, 2005, the disclosure of which is incorporated by reference herein.

### FIELD OF INVENTION

The present invention relates to advertising methods over a network, such as the Internet. In particular, the invention is directed to methods for selecting at least one data object from multiple data objects in real time, typically in the form of banners, placed over a web page being browsed by a user, based on the behavior of the user.

### BACKGROUND OF THE INVENTION

Electronic advertising over networks, such as the internet, takes various forms. One such form is, for example, banner advertising.

Banner advertisements are formed of banners, that include text, images or combinations thereof, arranged in various shapes. The banners are inserted into horizontally or vertically displayed rectangles and other shapes of various fixed dimensions and locations on a web page, when the web page is displayed. The banner covers one or more links to an advertiser's web site (also spelled “website”).

A network user may use their mouse or other pointing device, to “click” on the banner that is linked to a web site. This click results in the user being directed to the web site represented by the banner. As the Internet continues to develop, banner advertisements are also appearing in forms such as pop-ups and roll (scroll) ups, while the underlying web page continues to be displayed.

Internet-based banner advertising is currently grouped into three primary market segments: advertising networks, individual publishers and contextual networks. Over ninety percent of Internet-based banner advertising is purchased through one of these segments. Advertising networks are formed by enterprises that build private networks from thousands of web site publishers or owners. These enterprises run banners on their individual web sites in exchange for a percentage of the revenue generated by the advertising network(s) in which they participate. The web site owners provide the advertising network with access to their users and visitors, enabling the private network to distribute its banner advertisement campaigns.

Advertisers normally also pay for placement of their banner advertisements directly onto individual web site publishers. The individual web sites that tend to receive the most requests for banner placement directly on their web pages are often those that are generating substantial “traffic,” meaning visitors, to the individual web sites.

Additionally, depending on a particular web site, an advertiser may also be able to place their banner advertisements on one or more particular pages of a web site, that carry one or more common themes. For example, a web site of a news service may include pages for news, sports, weather and financial news, such that the advertiser's banners will appear on all of these web pages including the home page. Additionally, advertisers may be able to purchase demographic and/or geographic data collected from visitors to the web site who have registered with the web site, and voluntarily provided additional information about themselves.

Banner advertisements are displayed to users randomly or through contextual advertising technology. Other methods of displaying banners may be based on targeting through demographic or geographic criteria. Some banners are displayed utilizing a performance optimization metric, by which an advertiser removes its banner advertisements from web pages with low click-through rates (“click-through” meaning that a click on the advertiser's banner will direct the user to the advertiser's targeted web site”) and concentrates their display on web pages having high click-through rates.

Additionally, some of the most significant industry participants who successfully deployed contextual banner advertising technology have remained with textual, rather than graphical banner advertisements. Graphical advertisements are often more appealing to users, than text-based advertisements. Accordingly, they tend to receive more responses, and therefore, tend to be more profitable when compared to text-based advertisements.

Contextually targeted advertising is a popular method for placing banner advertisements. Contextually targeted banner advertisements are banners placed within web pages that are of a common or related theme, typically based on keywords. The keywords are typically associated with a particular advertising campaign. Contextual banner advertising may be performed over contextual banner networks.

Contextual banner networks are enterprises that have established a private banner advertising network, and which further provide technology to web site owners within the private network, permitting them to determine the content of a web page and serve banner advertisements with relevant offerings.

For example, a web page for weather information may contain keywords such as, for example, “umbrella,” “ski jacket,” “suntan lotion,” “gloves,” or “sunglasses.” These keywords may appear as part of the text displayed on the web page itself, such as the headline of, “Rain likely; take your umbrella to the office today.” Alternatively, the keywords may be programmed or coded in a manner that a regular network user may not notice, but which can be read by industry accepted automated procedures, such as web crawlers and other applications that collect keywords based on Uniform Resource Locator (URL) address.

### SUMMARY OF THE INVENTION

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen display, for example, a banner covering an activatable link, that causes an action of the various software and or hardware supporting the computer screen display.

A banner is a graphic that appears on the monitor of a user, typically over a web site or web page being viewed (browsed). A banner may appear on the web page in forms such as inserts, pop ups, roll ups, scroll ups, and the like.

A “web site” is a related collection of World Wide Web (WWW) files that includes a beginning file or “web page” called a home page, and typically, additional files or “web pages”. The term “web site” is used collectively to include “web site” and “web page(s)”.

A uniform resource locator (URL) is the unique address for a file, such as a web site or a web page, that is accessible on the Internet.

A server is typically a remote computer or remote computer system, or computer program therein, that is accessible over a communications medium, such as the Internet, that provides services to other computer programs (and their users), in the same or other computers.

Pay Per Click (PPC), also known as price per click and cost per click, as used herein, is the amount of money that an advertiser, web site promoter, or other party who owns or is associated with a web site or web page, will pay to a system administrator for providing their advertisement, banner, listing, link or the like to a user, and the user clicks their mouse or pointing device on the advertisement, banner, listing, link or the like, such that the user's browser is directed to the targeted web site associated with the advertiser, web site promoter, or other party who owns or is associated with the targeted web site.

“n” and “nth” in the description below and the drawing figures represents the last member of a series or sequence of servers, components, listings, links, data files, etc.

“Click through” or “click throughs” are industry standard terms for a user clicking on a link in an electronic object, such as an e-mail, banner, listing on a web site, for example, a web site of a search engine, or the like, and ultimately having their browser directed to the targeted data object, typically a web site, associated with the link.

“Cookie” or “Cookies” are information that a server puts on the hard disc of a user's computer or computer type device at an initial time so that information about that user's browser or browsing application, for example, preferences when using a particular web site, can be used at a later time. More technically, “cookies” are information that is stored by the server on the client side, of a client/server communication.

The present invention overcomes the problems of the contemporary art by providing a system, that provides banners to the web sites or web pages of publishers, of a publisher network, that are being browsed by users. The banners provided to the web sites or web pages are banners that are of particular relevance to the browsing user, based on the past browsing behavior of the user. As long as the banners served to the web pages being browsed, when activated, redirect (direct) the browser of the user to a web site hosted by a server of the publisher network, a continuous, and theoretically endless, session of web sites or web pages with banners may be browsed.

The invention also utilizes cookies for evaluating the behavior of a user, in order to determine the banners to serve to the web pages being browsed by the user. By using cookies, the system can pick up behaviors of a user across various web sites and web pages. This allows a banner, specifically targeted to the particular user, to be sent to the browser of the user, when the user is browsing a web site or web page of the publisher network (e.g., hosted by a server of the publisher network).

An embodiment of the invention is directed to a method for delivering a banner to a data object, for example, a web site or a web page. The method includes, obtaining a list of banners for the data object, from responses to banners from each user in a group of users; obtaining data for at least one user, from at least one response to at least one banner; and, serving at least one banner from the list of banners to the data object being browsed by at least one user, in accordance with the data obtained from the at least one user from the at least one response to the at least one banner.

Another embodiment of the invention is directed to a system for delivering a banner to a data object, for example, a web site or a web page. The system includes three components. There is a first component for obtaining a list of banners for the data object, from responses to banners from each user in a group of users. There is a second component for obtaining data for at least one user from at least one response to at least one banner. There is a third component for serving at least one banner from the list of banners to the data object being browsed by at least one user, in accordance with the data obtained from the at least one user from the at least one response to the at least one banner.

Another embodiment of the invention is directed to a programmable storage device readable by a machine, tangibly embodying a program of instructions executable by a machine to perform method steps for delivering a banner to a data object, for example, a web site or web page. The method steps are selectively executed during the time when the program of instructions is executed on the machine. The method steps include, obtaining a list of banners for the data object, from responses to banners from each user in a group of users, obtaining data for at least one user, from at least one response to at least one banner; and, serving at least one banner from the list of banners to the data object being browsed by at least one user, in accordance with the data obtained from the at least one user from the at least one response to the at least one banner.

Still another embodiment of the invention is directed to a method for delivering a banner to a data object, for example, a web site or a web page. The method includes obtaining a list of banners for the data object, from responses to banners from each user in a group of users, and electronically maintaining at least one first database of the list of banners, with the banners of the list of banners correlated into pairs. The method also includes obtaining data from at least one cookie from the browser of at least one user, for at least one response to at least one banner, and electronically maintaining at least one second database of the response data from the at least one cookie. The at least one banner is then served from at least one correlated pair of banners from the list of banners in the at least one first database to the data object being browsed by at least one user, in accordance with the data in the at least one second database.

### BRIEF DESCRIPTION OF DRAWINGS

Attention is now directed to the drawings, where like reference numerals or characters indicate corresponding or like components. In the drawings:

FIG. 1 is a diagram of an exemplary system on which an embodiment of the invention is performed;

FIGS. 2A and 2B are a diagram of exemplary databases for FIG. 1;

FIGS. 3A and 3B are a flow diagram of a method in accordance with an embodiment of the invention;

FIGS. 4A and 4B are a diagram illustrating an exemplary operation of the invention, as detailed in the flow diagram of FIGS. 3A and 3B;

FIG. 5 is a screen shot of an exemplary web page being browsed by a user;

FIG. 6 is a screen shot of an exemplary web page showing a banner served or sent in accordance with the invention to the web page of FIG. 5;

FIG. 7 is a screen shot showing a web page accessed from a redirect uniform resource locator associated with the banner on the web page of FIG. 6, and a banner sent in accordance with the invention; and,

FIG. 8 is a screen shot showing a web page accessed from a redirect uniform resource locator associated with the banner on the web page of FIG. 7, in accordance with the invention.

### DETAILED DESCRIPTION

Throughout this document, textual and graphical references are made to fictional trademarks as well as Internet addresses (Uniform Resource Locators, also known as URLs). These trademarks and Internet addresses are fictitious and for explanation purposes only, and any association with any party or other entity is coincidental, unintentional and unrelated thereto. Throughout this document, numerous textual and graphical references are made to trademarks. These trademarks are the property of their respective owners, and are referenced only for explanation purposes herein.

The invention includes a system that serves (provides or delivers) banners to data objects, such as web sites and web pages being browsed by a user, in accordance with the user's behavior in responding or not responding to banners being previously served to web sites or web pages he browsed previously. The banners are delivered to the web page being browsed, based on behavioral targeting of the user, through the user's browser or browsing application. The web pages or web sites, composed of various web pages, on which the banners are delivered, are from a publisher network, while the banners are from advertisers in an advertiser network. Publishers in the publisher network may be advertisers in the advertiser network, and advertisers in the advertiser network may be publishers in the publisher network.

When a user clicks on the banner, their browser or browsing application is directed to the URL of the targeted web site or web page associated with the banner. If the targeted web site or web page is a publisher in the network, another banner associated with an advertiser in the network, will be sent to the targeted web site or web page being browsed, based on the behavior of the user as monitored by the system of the invention. This monitoring of user behavior is typically performed by using cookies, that are modified, each time a user clicks on a banner delivered to the web page being browsed by the system.

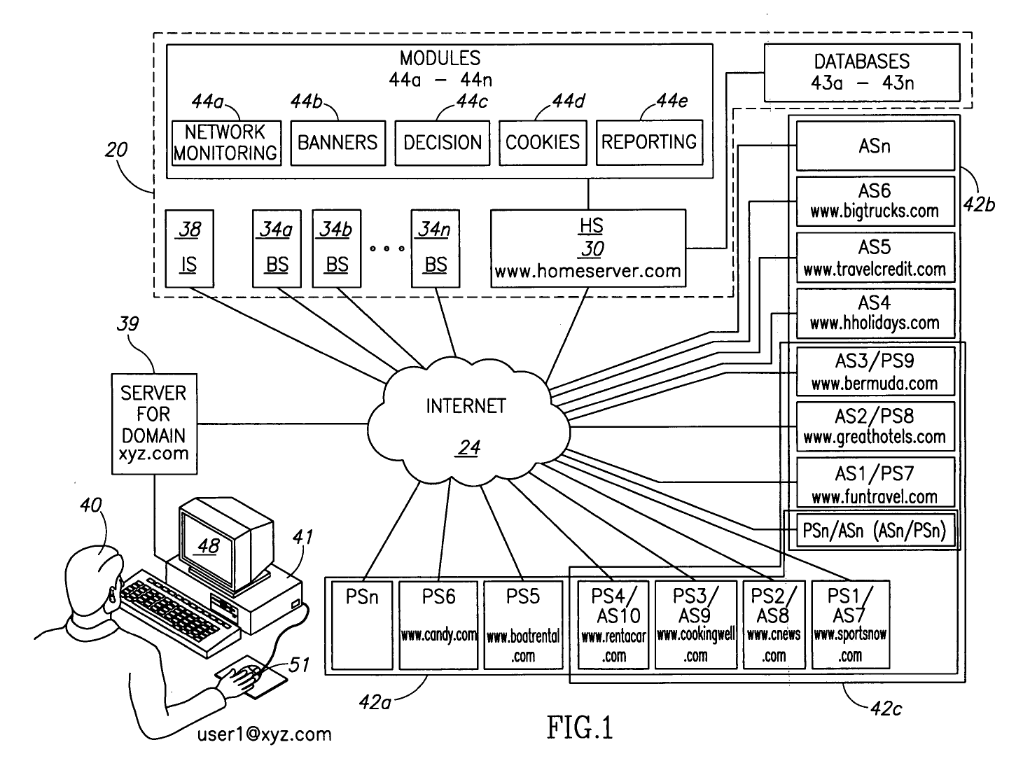

FIG. 1 shows the present invention in an exemplary operation. The present invention employs a system 20 (shown as a broken line box), formed of various servers and server components, that are linked to a network, such as a wide area network (WAN), and typically a public network, that may be, for example, the Internet 24.

There are, for example, at least three kinds of servers that form the system 20. These servers typically include a Home Server (HS) 30, one or more banner servers (BS) 34a-34n associated with the home server (HS) 30, and an imaging server (IS) 38. These servers 30, 34a-34n and 38 are linked to the Internet 24, so as to be in communication with each other. The servers 30, 34a-34n and 38 include multiple components for performing the requisite functions as detailed below, and the components may be based in hardware, software, or combinations thereof. The servers 30, 34a-34n and 38 may also have internal storage media and/or be associated with external storage media.

The servers 30, 34a-34n, 38 of the system 20 are linked (either directly or indirectly) to an endless number of other servers and the like, via the Internet 24. Other servers, exemplary for describing the operation of the system 20, include a domain server 39 for the domain (for example, the domain “xyz.com”) of the user 40 (also known throughout this document as “user1” and, for example, whose electronic mail (e-mail) address is user1@xyz.com), linked to the computer 41 of the user 40. The user 40 is representative of multitudes of users who will browse various web sites and web pages, so as to be served banners over these web pages by the home server (HS) 30, servers (such as banner servers (BS) 34a-34n) or components associated therewith, in accordance with the invention.

Still other servers may include third party servers PS1-PSn, associated with a publisher network (PN), indicated by the box 42a, third party servers AS1-ASn, associated with an advertiser network (AN), indicated by the box 42b, with some servers being members of both networks, as indicated by the box 42c. The servers PS1-PSn and AS1-ASn of the publisher and advertiser networks are typically controlled by content providers, web site promoters, and the like. The enterprises controlling the servers of the publisher and advertiser networks are typically distinct from the enterprise, party or entity controlling the home server (HS) 30.

The publishers, Publisher 1 to Publisher n, in the publisher network 42a, 42c, are associated with the corresponding servers PS1-PSn. The publishers are enterprises whose web pages, of the web sites supported by these servers PS1-PSn, that when browsed, will have banners served or sent, typically along with a cookie (or cookies) to these web pages, in accordance with the invention, typically by or via the home server (HS) 30.

The publishers (Publisher 1 to Publisher n), in the publisher network (for example, as represented by the servers PS1-PSn), typically incorporate code or data in their web sites and their web pages, that can be detected by the home server (HS) 30, that is monitoring the network. The data is typically sent to from the browser of the user browsing the web site or web page to the home server (HS) 30. The data typically includes a request to serve the banner to the web site or web page being browsed by the user and a cookie(s) or cookie information. Once the publisher web site or web page is detected as being browsed, the home server (HS) 30 can activate its banner functionalities to serve or send the requisite banner, typically with the cookie(s) to the web site or web page in the web browser being browsed by the specific user (specific intended recipient).

The banners that are sent to the specific user (specific intended recipient), typically are those of the advertisers, for example, Advertiser 1 to Advertiser n, of the advertiser network 42b, 42c, whose corresponding servers AS1-ASn, support the targeted web sites associated with the banners sent to the web pages of the publishers (for example, Publisher 1 to Publisher n) being browsed by the users. For explanation purposes, each publisher server (PS1-PSn) is been provided with a URL, as is each advertiser server (AS1-ASn), and each server that functions as both a publisher server and an advertiser server (PS/AS and AS/PS and may be referred to as PS or AS depending on whether it is performing a function as a publisher server or an advertiser server at the instant time). For example, server PS1/AS6 has the URL www.sportsnow.com, and supports the web site of Sports Now Magazine. Server AS1/PS7 has the URL www.funtravel.com, and supports the web site of a travel entity. Server PS5 has the URL www.boatrental.com (boat rentals for travel destinations), and supports the web site of a boat rental entity, while server AS5 has the URL www.travelcredit.com (a site concerning travel funds, such as debit cards and travelers checks and other currency instruments to travelers), and support a web site of an entity that provides credit to travelers.

While various servers have been listed, this is exemplary only, as the present invention can be performed on an endless numbers of servers and associated components, that are in some way linked to a network, such as the Internet 24. Additionally, all of the aforementioned servers include components for accommodating various server functions, in hardware, software, or combinations thereof, and typically include storage media, either therein or associated therewith. Also in this document, the aforementioned servers, storage media, and components can be linked to each other or to a network, such as the Internet 24, either directly or indirectly.

The Home Server (HS) 30 is of an architecture that includes components, such as databases 43a-43n and modules 44a-44n (some modules 44a-44e specifically shown and discussed) and the like, for handling numerous operations and applications. The home server (HS) 30 is shown for example, as a single server, but it may be made up of numerous servers along the public network (i.e., the Internet 24) or along a local network, or combinations thereof. For example, the banner servers (BS) 34a-34n typically function in conjunction with the home server (HS) 30 to perform numerous functions associated with banner storage, creation and delivery (serving) to the web sites or web pages, as determined by the modules 44a-44n of the home server (HS) 30. The databases and caches 43a-43n and modules 44a-44n may be in single or separate components, as described for the home server (HS) 30.

The modules 44a-44n of the home server (HS) 30, include modules for network monitoring 44a, banner monitoring and inventory (of the banner servers (BS) 34a-34n) 44b, determining the banner to be sent 44c, cookies 44d, and reporting 44e (e.g., recording clicks for banners that were responded to, as well as record click throughs to targeted web sites, as well as banners that were not responded to). The architecture also includes components for providing numerous additional server functions and operations, for example, comparison and matching functions, policy and/or rules processing, various search, and other operational engines.

The home server (HS) 30 may also include an architecture (including databases and caches 43a-43n and modules 44, for supporting banners 44b and other electronic communications. The architecture includes components, modules and the like, for handling banners, to perform banner server functionality, including banner applications.

While databases 43a-43n are shown, this is exemplary only. The Home Server (HS) 30 may be associated with databases, as well as numerous other additional storage media, both internal and external thereto.

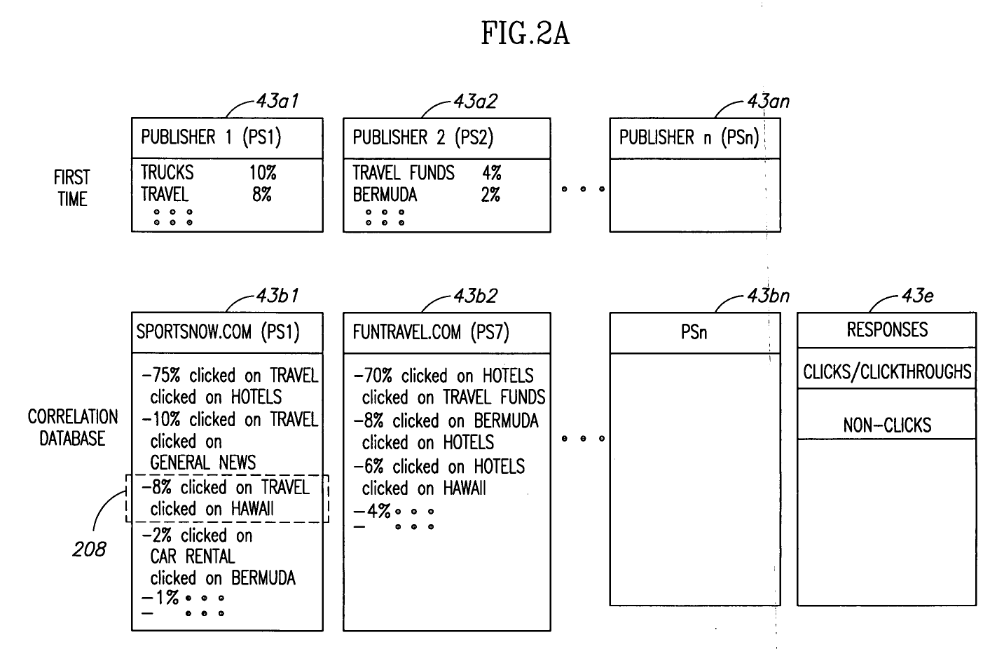

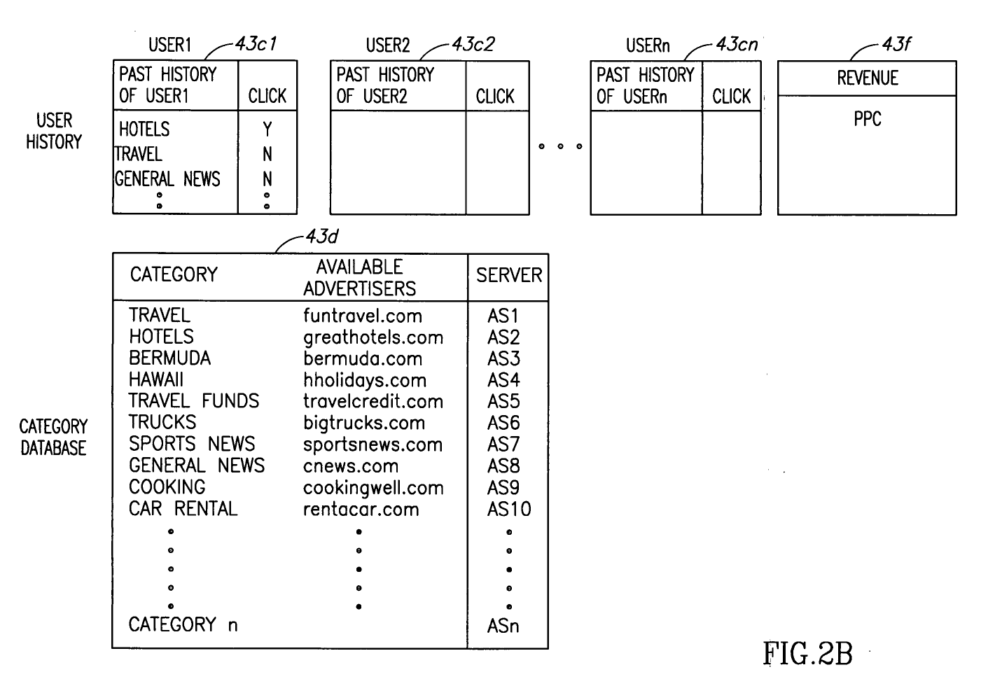

The Home Server (HS) 30 includes various processors, including microprocessors, for performing the aforementioned server functions and operations. It also includes storage media, either internal or associated therewith, such as databases 43a-43n. FIGS. 2A and 2B, detailed below, shows diagrams of the databases 43a-43n, with some databases 43a-43f specifically shown and discussed. The databases 43a-43n may also include other data structures for data storage and manipulation.

In addition to the network monitoring module 44a and banner 44b modules, discussed above, another module that operates in conjunction these modules is a decision module 44c. The decision module 44c selects the banner category in the requisite banner server (BS) 34a-34n (the category matched in the category database 43d to provide the link in the banner, to the URL of the targeted web site or web page), to be sent to the web page being browsed by the requisite user. It typically selects the web page based on an examination of the cookies in the browser of the requisite user. However, it is also programmed to randomly send banners. This random sending typically occurs when the user appears for the first time to the monitoring module 44a.

The cookie module 44d, sends cookies (to the browser of the requisite user) with the banners sent, and updates the cookies. This module 44d also performs other functionalities typically associated with cookies.

The Home Server (HS) 30 composes and sends banners to web pages of intended recipients (for example, the web pages being browsed by a computer, workstation or other computing device, etc., associated with a user), over the network, typically a wide area network (WAN), such as the Internet 24. The home server (HS) 30 receives responses and other data sent from the banner being responded to (“clicked on” or activated). In this document, the client is, for example, an application that runs on a computer, workstation or the like, and relies on a server to perform some operations, such as sending and/or receiving banners, cookies, and the like. Also, for explanation purposes, the Home Server (HS) 30 may have a uniform resource locator (URL) of, for example, www.homeserver.com.

For example, the intended recipient or user 40 has a computer 41 (such as a multimedia personal computer with a Pentium® CPU, that employs a Windows® operating system). The computer 41 also has a web browser or browsing application, for example, Internet Explorer® from Microsoft Corp. of Redmond, Wash., Netscape Navigator®, from Netscape Corp. The computer 41 is linked to the Internet 24. The recipient or user 40 also has a mouse or other pointing device 51, useful for functions including, activating or “clicking” on banners and for browsing the Internet 24.

The banner servers (BS) 34a-34n are representative of a multitude of banner servers, for providing banners that cover links to targeted web sites. The banner servers (BS) 34a-34n are typically high traffic capacity servers, and include software for determining the size of the banner that the URL will accommodate. The banner servers (BS) 34a-34n store the media for each banner, including Hypertext Markup Language (HTML) code, flash code, image text, and other data, such as size (dimensions) of the banner and formatting data, for each corresponding banner. The graphical images are typically sent to the homer server (HS) 30, for serving the banner to the requisite web site or web page. However, depending on the style of the banner, portions of the data forming the banner may be sent to the imaging server (IS) 38, to be converted into images, and then to the home server (HS) 30, that will serve the banner to the requisite web site or web page.

Banners are published or delivered on web pages by numerous commonly known processes. In one process, a web page, typically a web page supported by a publisher server (PS), that is encoded, for example, in JavaScript™ and hypertext markup language (HTML). The encoded web page queries the home server (HS) 30, for example, the monitoring module 44a, for a banner advertisement, when the web page is accessed by a user (on the network 24). The banner module 44b, works with the network monitoring module 44a and the decision module 44c, to receive data from the web page being browsed, to determine the specific banner advertisement to be server to the web page being browsed by the user. The specific banner is obtained from the requisite banner server (BS) 34a-34n. The requisite banner server (BS) 34a-34n, typically sends the banner to the home server (HS) 30, that serves banner with an activatable link to the URL for the targeted web site of the advertiser, typically in the advertiser network 42b, 42c, and in some cases with a cookie(s), to the web-page being browsed. Alternately, the banner servers (BS) 34a-34n may perform this function.

At least one imaging server (IS) 38 is linked to the Internet 24. The imaging server (IS) 38 functions to convert portions of data from the banner servers (BS) 34a-34n, to one or more images (data in an image format), when necessary. After conversion into an image, the image is typically sent back to the Home Server (HS) 30, for its being served or sent to the particular web page being browsed by the requisite user.

The home server (HS) 30 also includes modules, such as recording and reporting module 44e, that performs administrative and reporting functionalities. This module 44e may be programmed to perform functions such as limiting the number of banners associated with a specific advertiser that are sent, creates and modifies behavior profiles of users, and sets up advertiser and publisher accounts. Reporting functionalities include metrics for management of the system, campaign lists (enabling a system administrator to view for example, specific banners, key statistics and performance reports. Reporting functionalities for users include user identifications, total impressions, clicks generated, click through rate, price per click, total revenue, queried by date.

Turning to FIGS. 2A and 2B, shown are various databases 43a-43n associated with the home server (HS) 30. These databases are exemplary only, and represent the basic types of databases associated with the various publishers, advertisers and users of the system 20. All of these databases are dynamic, in that their content is always changing, typically because of the behavior of users, as they respond or not respond to various banners served onto web sites or web pages on which they are browsing. First time databases 43a1-43an, correlation databases 43b1-43bn, and user history databases 43c1-43cn, include categories, that are listed with URLs for presently available web sites or web pages, for each category, and the servers of the advertiser network that host these web sites or web pages for each category, in one or more category databases, for example, database 43d. As the data stored in the databases is constantly changing, the stored data is at positions ranging from a first position to an nth position.

Initially, databases 43a1-43an are for each publisher (Publisher 1 to Publisher n) and the banners that will be sent to the web page being browsed by a user on the first appearance of the user into the system. For example, for Publisher 1 (www.sportsnow.com), at server PS1, should a user in the first instance be browsing the corresponding web site (including the web pages that form the site), the first banner sent may be a banner for the category “trucks”, for example, the banner for the link to the URL of the targeted web site of www.bigtrucks.com, hosted by the server AS6. The correlation between the category TRUCKS and the URL for the web site www.bigtrucks.com for the instant time is shown, for example, in the category database 43d of FIG. 2B. If a response is not received to this banner, the next time this user browses this web site of Publisher 1, he will receive a banner for the category “travel”, for example, a banner for the link with the URL of the targeted web site www.funtravel.com, hosted by the server AS1/PS7.

Databases 43b1-43bn are correlation databases for the various categories, that presently correspond web sites or web pages hosted by the various advertiser servers AS1-ASn of the advertiser network 42b, 42c. The correspondence of the category, to the presently available web sites/web pages hosted by the advertiser servers AS1-ASn is shown in the category database 43d (FIG. 2B). These databases 43b1-43bn detail relations between various categories for banner serving, when these banners appeared on the requisite publisher's web site or web page (hosted by the corresponding server PS1-PSn). These correlation databases 43b1-43bn are built by multitudes of users (a group of users) responding to various banners, served previously to the web site or web page of the specific publisher, on which each individual user of the group, was browsing. The responses to the banners, along with subsequent responses to subsequent banners originating from browsing the initial web page is recorded for each user, and correlated into the correlation database for each web page of each publisher.

Banner correlations are typically arranged in pairs. For example, in the correlation database 43c1, for publisher 1, Sports Now Magazine (www.sportsnow.com, hosted by the server PS1), there is a correlation of “75% of users who ‘clicked’ on the category ‘travel’ (TRAVEL), clicked on the category ‘hotels’ (HOTELS).”

Specifically, for example, from the correlation database 43b1 and the category database 43d, a user browsing the web site of Sports Now Magazine, is served the banner for the for the link to the URL of the targeted web site of www.funtravel.com (for the category TRAVEL), on the monitor 48. Upon activating (“clicking” on) the banner, the user's browser is directed to the web site of www.funtravel.com, with a banner for the link to the URL www.greathotels.com (for the category HOTELS), then served or sent to the web page of www.funtravel.com, that is being browsed (once the browser of the user has been directed to this web site or web page). However, if the previous user history database showed a previous response (activation or “click”) to the category TRAVEL, then a banner in the category HOTELS would be served to the web page being browsed by the user.

Databases 43c1-43cn are for the history of each user for their response to banners of various categories, during their browsing sessions of web sites or web pages. The banners are typically of advertisers (presently or formerly in the advertiser network), that correspond to the categories. The user history databases 43c1-43cn are populated by data from the cookie(s), when they are examined or read, by the home server (HS) 30 (in the cookie module 44d). The data is received upon each examination of the cookie(s) (including when updated) from the browser of the particular user. These user history databases 43c1-43cn include data in addition to that obtained from the cookie. For example purposes, the user history data in the requisite user history databases 43c1-43cn mirrors the most recent data in the cookie. Accordingly, for example, in the User History database 43c1, user1 previously activated or “clicked” on a banner for the category “travel”, but did activate or “click” on banners for the categories “hotels” or “general news.”

Database 43e is for various recording functions detailed above. For example, this database may be for recording clicks and click throughs, as well as non-click events, where a banner delivered to a web page being browsed by the user was never clicked on or responded to. Database 43f is for recording results, such as those associated with pay per click (PPC) data, values and expenses associated with banners that are “clicked” on, and the browser of the user is directed to the targeted web site associated with the banner.

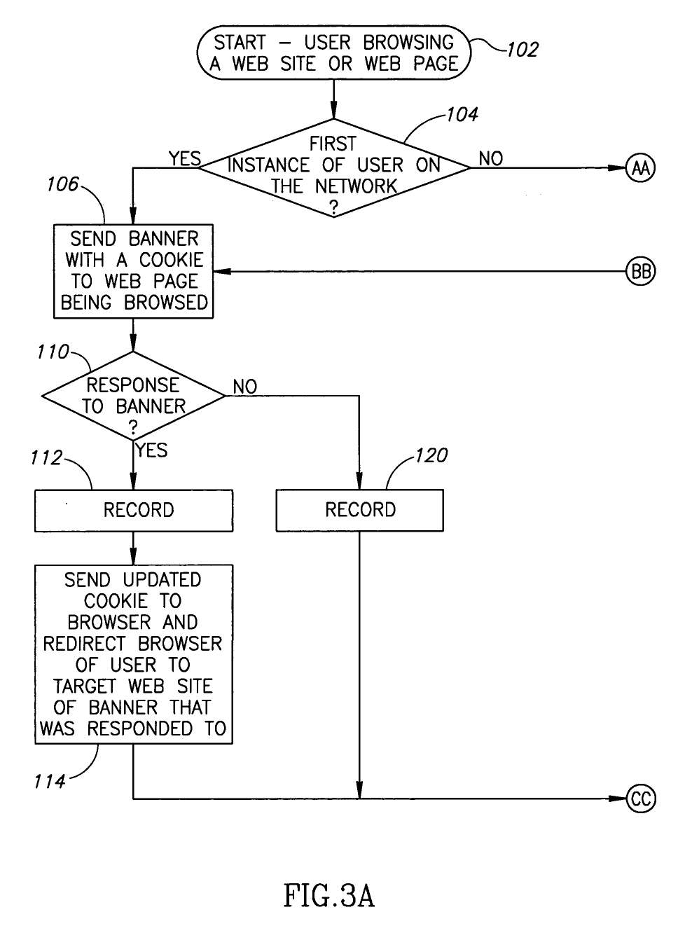

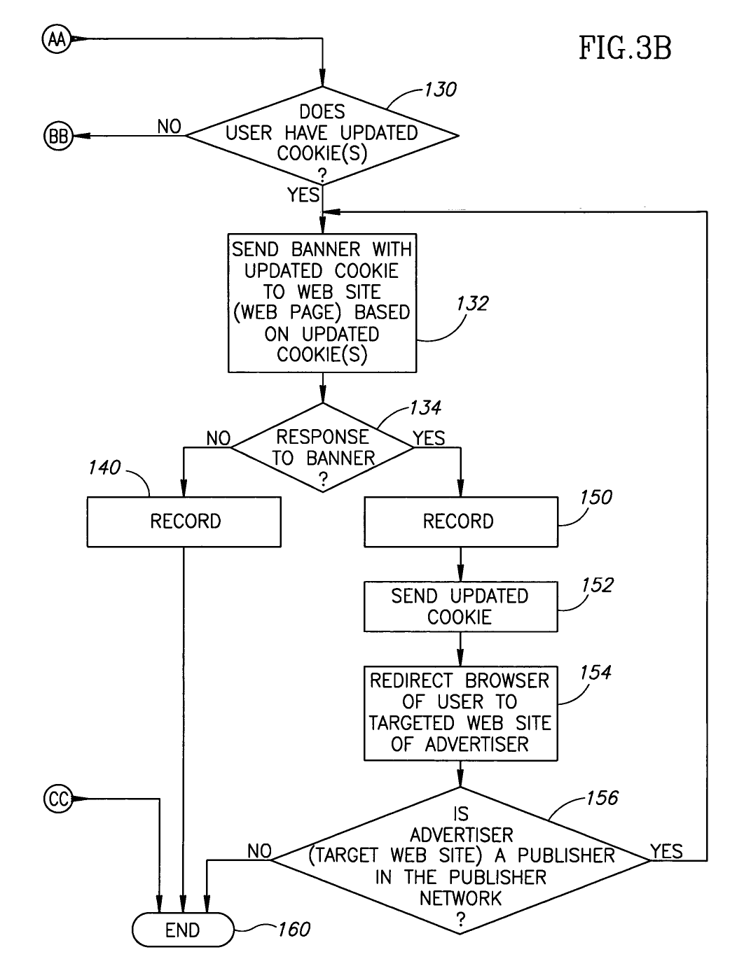

Turning also to FIGS. 3A and 3B, an exemplary implementation of a process, typically performed by the home server (HS) 30 alone, or with the servers (such as the banner servers (BS) 34a-34n) or components associated therewith, in accordance with an embodiment of the present invention, will now be described.

The process (method) begins at block 102, where a user is browsing a network, for example, the Internet. The browser or browsing application of or associated with the user is on a web site or web page hosted by a publisher server (PS1-PSn) and this has been detected by the home server (HS) 30, typically by monitoring and detection module 44a detecting data from the publisher's web page, upon its being browsed by the user.

The process moves to block 104, where it is determined if this is the first instance of the particular user browsing web pages associated with a publisher in the publisher network 42a, 42b. This is performed, for example, by the decision module 44d, in the home server (HS) 30 polling the database 43a-43n to see if any cookies have been sent to the particular user. If this is the first instance of this particular user, browsing a web site or web page of a publisher of the publisher network 42a, 42b, a banner is served or sent with a cookie (for module 44d), to the web site or web page being browsed, at block 106. If there is a response to the banner, at block 110, by it being activated, for example, by being “clicked”, the click is recorded at block 112, in the requisite database, for example, the database 43d, or other similar database. The cookie is also sent back to the homer server (HS) 30, that updates the cookie to indicate the response (activation or “click”) to the banner.

The hone server (HS) 30 sends an updated cookie to the browser or browsing application of or associated with the user. The browser or browsing application of or associated with the user is then redirected to the targeted web site associated with the banner that was responded to or activated, at block 114. The process then ends at block 160.

Turning back to block 110, if there is not a response to the banner by the user, the non-response is recorded at block 120. This non-response is typically by a time out or default setting, by the user closing the banner, or changing the web site or web page, the banner is removed from the web page and replaced with another banner, as part of banner refreshment on the web page, or any event where the banner is no longer available for activation by the user, hereinafter, known as a “non-responsive event.” The non-responsive event is recorded, for example, in the database 43d or other similar database. The process moves to block 160, where it ends.

Returning to block 104, if this is not the first instance of the user browsing a web site or web page of a publisher of the publisher network 42a, 42b (the publisher network represented by servers PS1-PSn), the process moves to block 130. At block 130, it is determined if an updated cookie has been placed into the browser or browsing application of the user. If the cookie, initially sent to the browser of the user, has not been updated, the process moves to block 106, and proceeds from block 106, as detailed above.

If the cookie (information obtained from the user as to categories, from banners, they have activated or “clicked” on) has been updated, the process moves to block 132, where the home server (HS) 30 or banner server (BS) 34a-34n (through the imaging server (IS) 38), serves or sends a banner with the updated cookie being further updated, to the web site being browsed. The particular banner that is sent is based on the correlation database 43b1-43bn, the category database 43d, and the User History database 43c1-43cn, that includes the data read in from the cookie in the browser of the requisite user.

The process moves to block 134, where it is determined if the user responded to the banner. If there is not a response, due to a non-responsive event (detailed above), this non-response, is, for example, recorded at block 140, for example, in the database 43d or other similar database. The process moves to block 160, where it ends.

Returning to block 134, if there is a response to the banner (by a “click” or the like), this response is recorded at block 150, with the response stored, for example, in the database 43d or other similar database. An updated cookie, indicating a response to the particular banner is sent to the browser (browsing application) of the user, at block 152. The updated cookie is the previously updated cookie sent with the banner, in block 132, that has been returned to the home server (HS) 30 and updated to include the response (activation or “click”) to the banner.

The process moves to block 154, where the browser or browsing application of or associated with the user is then redirected to the targeted web site associated with the banner that was responded to or activated. The process moves to block 156, where it is checked to determine if the advertiser (for whom the banner was server to direct the user to the targeted web site or web page associated with the advertiser) is a publisher in the publisher network. If the advertiser is not a publisher in the publisher network, the process moves to block 160, where it ends. However, if the advertiser is a publisher in the publisher network, the process returns to block 132, and continues as detailed above.

In the process detailed above, each banner may have a set or variable pay per click (PPC) value. When the requisite banner is activated or “clicked” on and the browser or browsing application is redirected (directed) to the target web site or web page associated with the banner. This “click through” this and all related PPC events are recorded in the database 43f.

The process (method) begins again, typically when the user moves to another web site or web page, by opening their browser or browsing application, browsing another web site or web page not from activating a banner, or browsing after a predetermined number of banners have been served to targeted web sites or web pages.

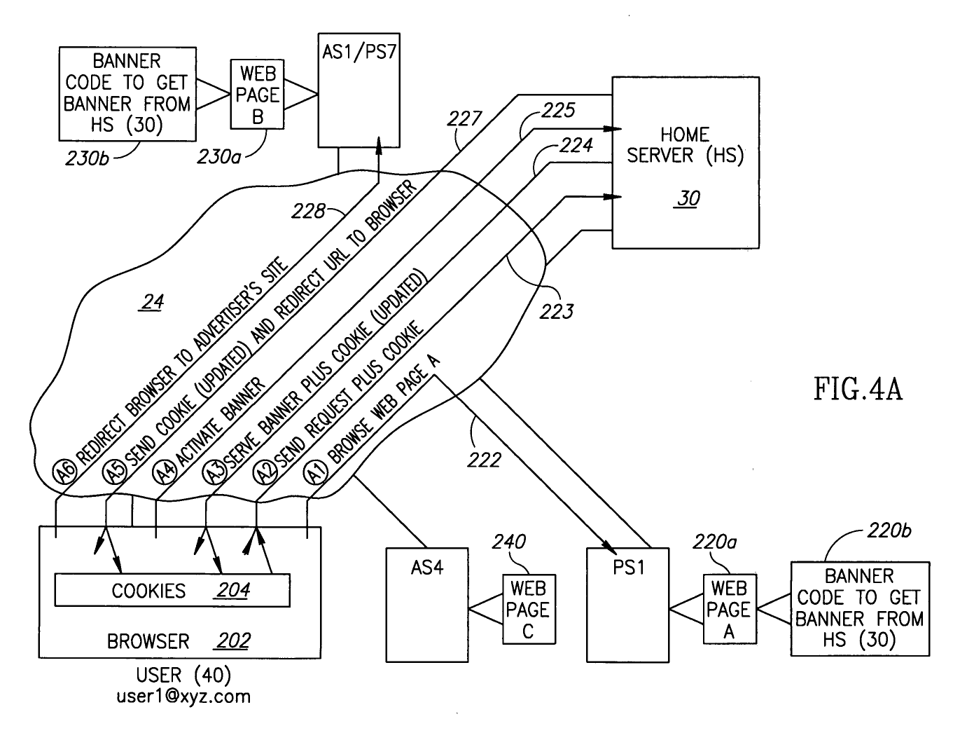

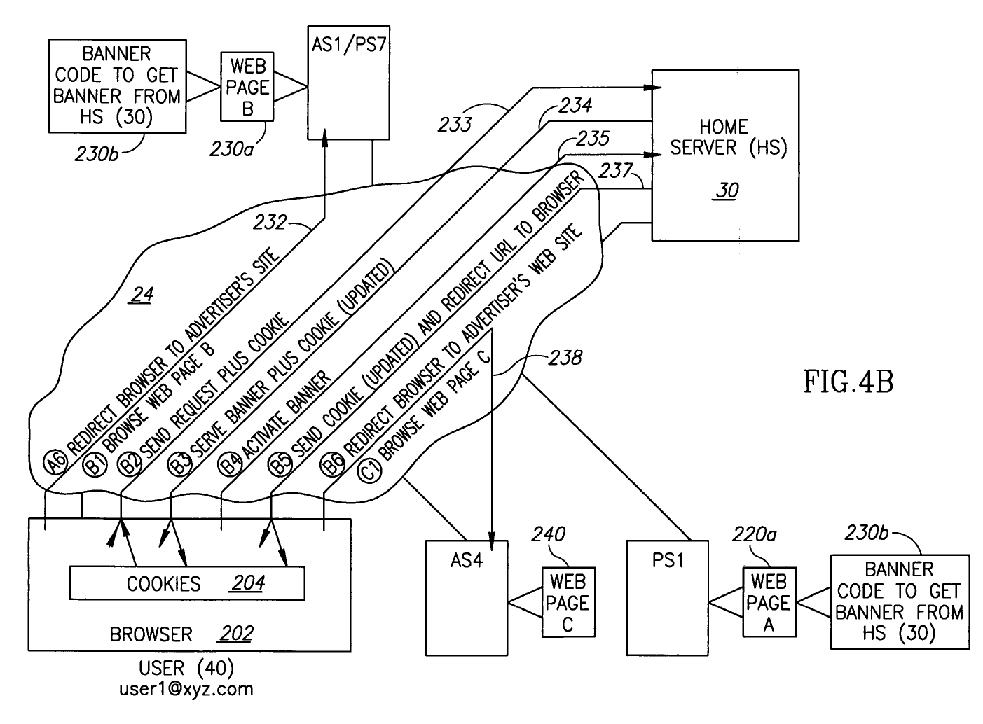

Attention is also directed to FIGS. 4A, 4B and 5-8, where an exemplary process in accordance with the system and method (process) detailed above is performed. In this process, the initial cookie is an updated cookie, as there is information known about the user 40, who has already activated a banner previously. Accordingly, the user has an updated cookie, as per block 130 of FIGS. 3A and 3B. In this exemplary process, the actions of the system 20 and non-system components are indicated in an order in accordance with circled identifiers A1-A6, B1-B6, and C1, this order and the actions detailed below.

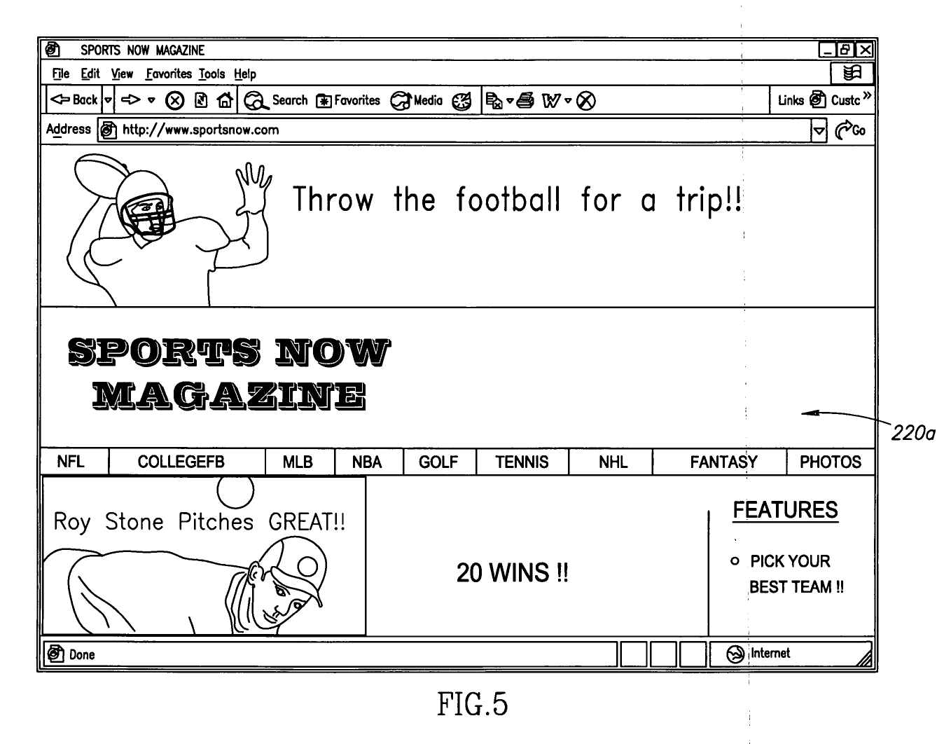

For purposes of this example, the user 40 (for example, user1, user1@xyz.com) is shown as a box, that encloses a box 202 representing a browser or browsing application, for example, Microsoft®Internet Explorer®, Netscape Navigator®, or other similar browser or browsing application. Within the browser 202 is an application for cookies 204. Initially, the user 40 (here, user1) is browsing the web site hosted by the server of publisher 1 (PS1), and in particular browsing a web page, shown as the screen shot of FIG. 5 (Web Page A 220a), associated with the web site of Sports Now Magazine, with URL of www.sportsnow.com, as indicated by the arrow 222.

The module 44a of the home server (HS) 30, has detected a web page of publisher 1 from server PS1, that is being browsed. This detection is, for example, data from code in the web page of the publisher 220b that is being browsed, that is sent to the home server (HS) 30 upon being browsed (arrow 223). The modules 44a, 44d have obtained data from the updated cookie 204 from the user's (user1) browser. Specifically, based on this updated cookie, the banner module 44b performs a lookup in the correlation databases 43b1-43bn. For example, for Sports Now Magazine (www.sportsnow.com), correlation database 43b1 is looked at. Additionally, the user history databases, here, for example database 43c1, for the instant user, user1, is checked, along with the category database 43d.

Looking at these three databases, correlation database 43b1, user history database 43c1, and category database 43d, and in particular, from the user history database 43c1, user1 responded to a banner for the category “travel”, but not for “hotels” or “general news.” Accordingly, based on user1's past behavior, he will be served banners with the correlation listed in the broken line box 208, as his user history indicates that although user1 responded to banners for the category “travel”, he did not respond to banners for the categories “hotels” and “general news.” For this reason, box 208, with the correlation of “8% of users who clicked on TRAVEL clicked on HAWAII” will result in these banners potentially being served to user1. Based on the category database 43d, banners will be served to the user1 with underlying links to the URLs for www.funtravel.com (for the category TRAVEL), and if responded to, www.hholidays.com (for the category HAWAII, of Advertiser 4, whose web site is hosted by server AS4). Accordingly, the user 40 (here for example, user1) has been delivered banners of relevance to him, in accordance with his past behavior, as taken from the User History database 43c1 (via the received cookie(s), that have been read).

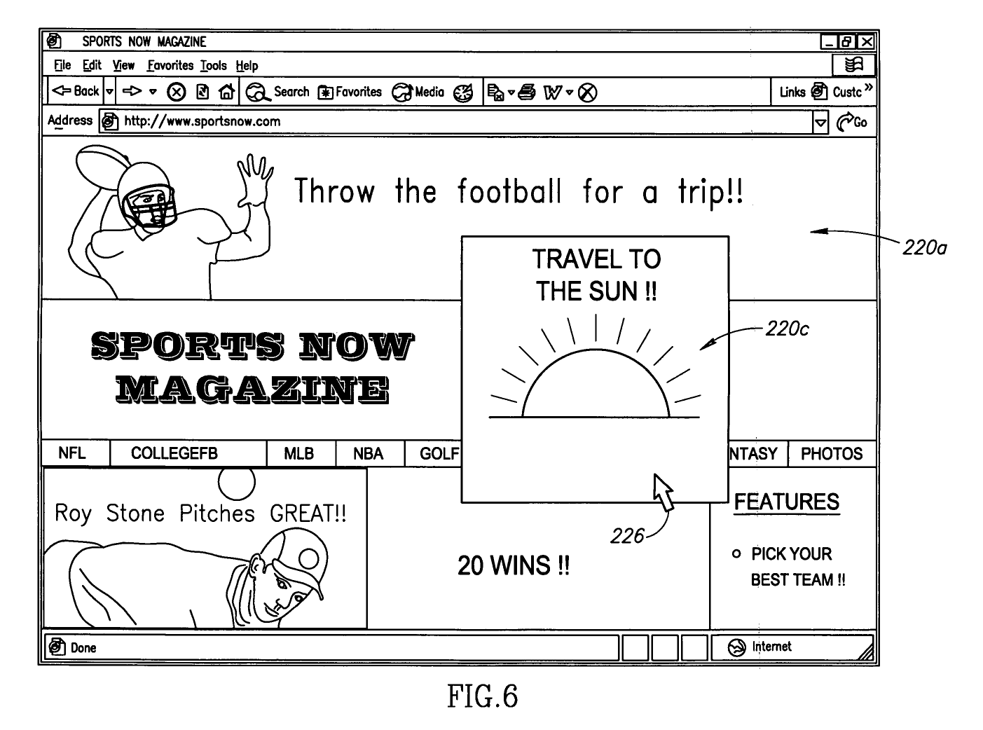

The first banner 220c is served or sent (block 132 of FIGS. 3A and 3B), with a cookie, from the home server (HS) 30 (or components associated therewith, including the banner servers (BS) 34a-34n), to Web Page A 220a, as per the arrow 224. The banner 220c (“TRAVEL TO THE SUN!!”) on Web Page A 220a is shown in the screen shot FIG. 6.

As shown in the screen shot of FIG. 6, the banner 220c is from Advertiser 1 (Fun Travel, for the “travel” category), whose web site and web pages are hosted by server AS1/PS7 of the advertiser and publisher networks, with the URL of www.funtravel.com. The banner 220c includes an underlying link, obtained via the home server (HS) 30, to the URL www.funtravel.com.

The user 40 responds to the banner 220c (block 134 of FIGS. 3A and 3B), by activating or “clicking” on it, as shown by arrow 225, and the arrow 226 of FIG. 6 (the response recorded in the database 43d as per block 150 of FIGS. 3A and 3B). A cookie, now an updated cookie, is returned as a further updated cookie, to the browser 202 of the user 40 (as per block 152 of FIGS. 3A and 3B), along with a redirect URL for the browser to the target web site or web page associated with the banner and its category (arrow 227), that is here, for example, www.funtravel.com, as per the category database 43d, and hosted by the server AS1/PS7.

The user's browser is redirected to the target web site of the advertiser, associated with the banner, as shown by arrow 228 (as per block 154 of FIGS. 3A and 3B). As the advertiser of the banner 220b is a publisher in the publisher network 42a, 42b, represented by server AS1/PS7, as per block 156, of FIGS. 3A and 3B, the process returns to block 132 of FIGS. 3A and 3B.

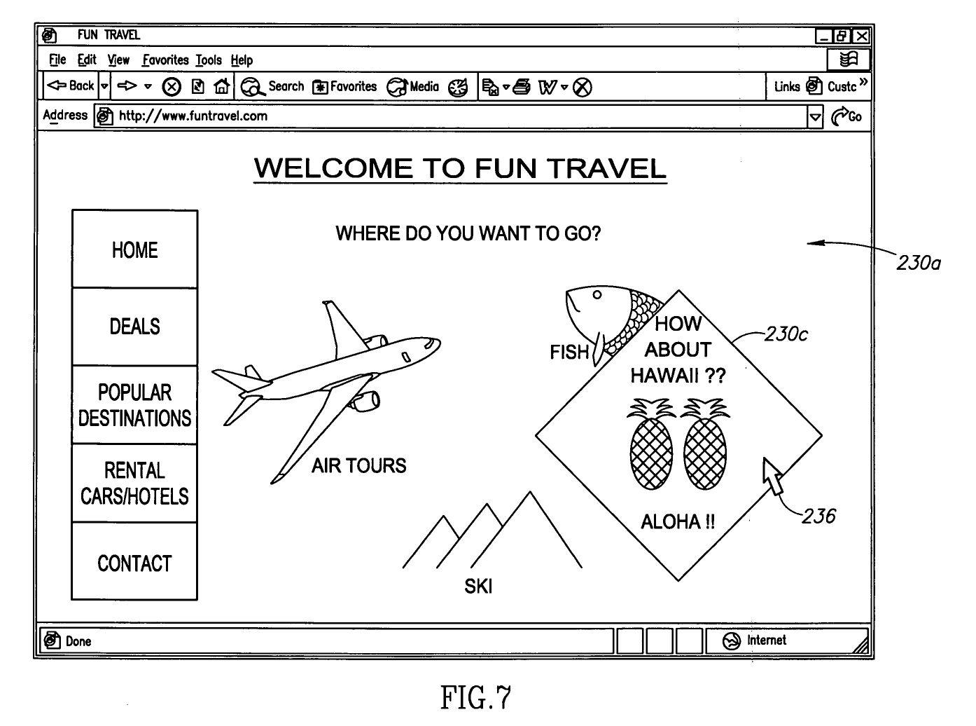

The user 40 (user1) is now browsing the web page (Web Page B) 230a (the web page 230a including code to get a banner from the home server (HS) 30 of box 230b) of the screen shot of FIG. 7, of the web site, www.funtravel.com (hosted by server AS1/PS7) (arrow 232). As detailed above, for Web Page A 220a, the browser 204 sends data, e.g., a request and a cookie to the home server (HS) 30, as per the arrow 233. The second banner (“HOW ABOUT HAWAII?”) 230c is served or sent (block 132 of FIGS. 3A and 3B), with a cookie (now updated), from the home server (HS) 30 or components associated therewith, including the banner servers (BS) 34a-34n, to Web Page B 230a in the browser 202, as per the arrow 234. The banner 231c on Web Page B 230a is shown in FIG. 7.

As shown in the screen shot of FIG. 7, the banner 231c is to the targeted web site and web pages are hosted by server AS4 (Advertiser 4, Hawaii Holidays, for the category ‘Hawaii”), with the URL of www.hholidays.com. The banner 231c, includes a link, obtained via the home server (HS) 30, to this URL.

The user 40 responds to the banner, by activating or “clicking” on it, as shown by arrow 235, and the arrow 236 of FIG. 7. This “click” is typically recorded, in the database 43d, as per block 150 of FIGS. 3A and 3B. A cookie, now an updated cookie, is returned as a further updated cookie, to the browser 202 of the user 40 (block 152), along with a redirect URL for the browser 202 to the target web site or web page associated with the banner 230c and its category (arrow 237), that is here, for example, www.hholidays.com, as per the category database 43d, and hosted by the server AS4. 1/PS7.

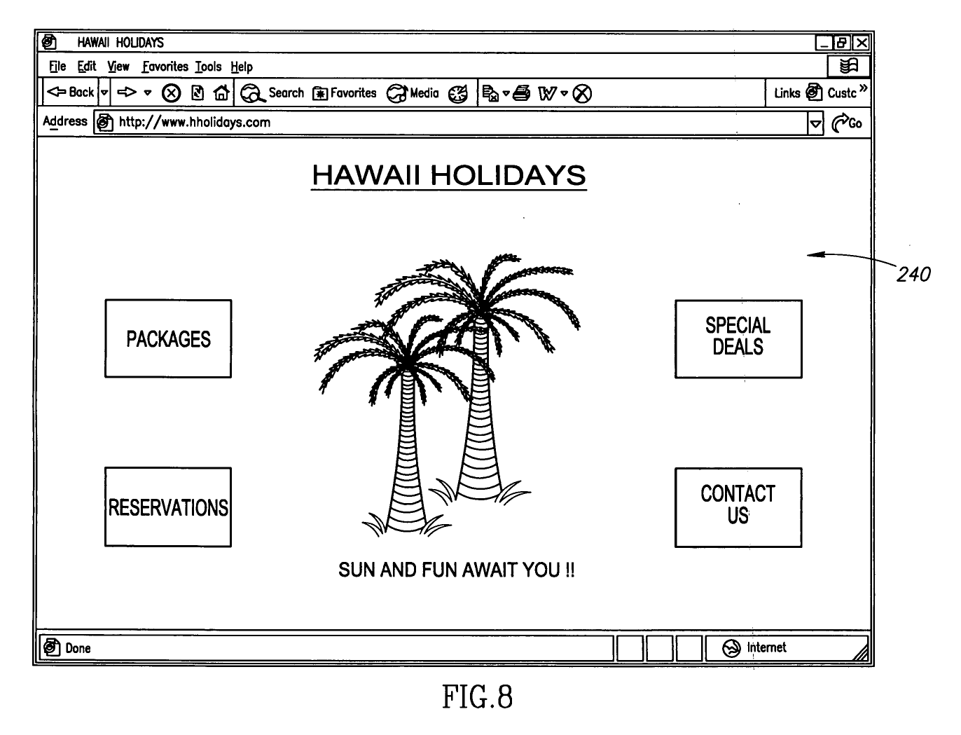

The user's browser is redirected (directed) to the target web site of the advertiser, associated with the banner, as shown by arrow 238 (as per block 154 of FIGS. 3A and 3B). The user 40 (for example, user1) is now browsing the targeted web site (web page), i.e., Web Page C 240, of the screen shot of FIG. 8, associated with the URL www.hholidays.com, and hosted by the server AS4 of the advertiser network 42b, 42c.

Server AS4 (representative of Advertiser 4) is not part of the publisher network, as per block 156 of FIGS. 3A and 3B. Accordingly, this example session for banner serving ends (as per block 160 of FIGS. 3A and 3B).

The above described methods (processes), including portions thereof, can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

1. A method for delivering a banner to a data object comprising:
obtaining a list of banners for the data object, from responses to banners from each user in a group of users;
obtaining data for at least one user, from at least one response to at least one banner; and,
serving at least one banner from the list of banners to the data object being browsed by at least one user, in accordance with the data obtained from the at least one user from the at least one response to the at least one banner.

2. The method of claim 1, wherein the data object includes a web page.

3. The method of claim 1, wherein the data object includes a web site.

4. The method of claim 1, wherein the at least one banner is served upon receiving data from the data object that it is being browsed.

5. The method of claim 4, wherein the data includes a request for at least one banner.

6. The method of claim 4, wherein the data additionally includes at least one cookie.

7. The method of claim 1, wherein the data object being browsed is hosted by a server type device that is part of a publisher network.

8. The method of claim 7, wherein the at least one banner served is associated with a target web site hosted by a server type device that is part of an advertiser network.

9. The method of claim 1, wherein the at least one response to at least one banner includes at least one of an activation of the at least one banner or a non-activation of the at least one banner.

10. The method of claim 1, wherein the responses to banners from each user in a group of users include activations of the banners.

11. The method of claim 1, wherein obtaining the list of banners includes obtaining at least one pair of banners correlated to the data object.

12. The method of claim 1, additionally comprising:
serving at least one cookie with the banner to obtain data about the at least one user when the at least one user is browsing the data object, and obtaining data for the at least one user by examining the at least one cookie.

13. The method of claim 1, wherein the group of users includes at least one user.

14. The method of claim 1, wherein the group of users includes multiple users.

15. The method of claim 1, wherein the at least one user includes an individual user.

16. A system for delivering a banner to a data object comprising:
a first component configured for obtaining a list of banners for the data object, from responses to banners from each user in a group of users;
a second component configured for obtaining data for at least one user from at least one response to at least one banner; and,
a third component configured for serving at least one banner from the list of banners to the data object being browsed by at least one user, in accordance with the data obtained from the at least one user from the at least one response to the at least one banner.

17. The system of claim 16, wherein the third component is additionally configured for serving the at least one banner upon receiving data from the data object that it is being browsed.

18. The system of claim 16, wherein the second component includes at least one module for sending and examining cookies.

19. The system of claim 16, additionally comprising at least one recording module configured for recording activations of banners on web pages being browsed by users in the group of users and recording activations and non-activations of the at least one banner by the at least one user, the recording module in communication with the first component and the second component.

20. The system of claim 16, wherein the first component for obtaining the list of banners is additionally configured for obtaining at least one pair of banners correlated to the data object.

21. A programmable storage device readable by a machine, tangibly embodying a program of instructions executable by a machine to perform method steps for delivering a banner to a data object, the method steps selectively executed during the time when the program of instructions is executed on the machine, comprising:
obtaining a list of banners for the data object, from responses to banners from each user in a group of users;
obtaining data for at least one user, from at least one response to at least one banner; and,
serving at least one banner from the list of banners to the data object being browsed by at least one user, in accordance with the data obtained from the at least one user from the at least one response to the at least one banner.

22. The programmable storage device of claim 21, wherein the data object includes a web page.

23. The programmable storage device of claim 21, wherein the data object includes a web site.

24. The programmable storage device of claim 21, additionally programmed, wherein the at least one banner is served upon receiving data from the data object that it is being browsed.

25. The programmable storage device of claim 21, wherein the at least one response to at least one banner includes at least one of an activation of the at least one banner or a non-activation of the at least one banner.

26. The programmable storage device of claim 21, wherein the responses to banners from each user in a group of users include activations of the banners.

27. The programmable storage device of claim 21, wherein obtaining the list of banners includes obtaining at least one pair of banners correlated to the data object.

28. The programmable storage device of claim 21, additionally programmed to:
serve at least one cookie with the banner to obtain data about the at least one user when the at least one user is browsing the data object, and obtaining data for the at least one user by examining the at least one cookie.

29. The programmable storage device of claim 21, wherein the group of users includes at least one user.

30. The programmable storage device of claim 21, wherein the group of users includes multiple users.

31. The programmable storage device of claim 21, wherein the at least one user includes an individual user.

32. A method for delivering a banner to a data object comprising:
obtaining a list of banners for the data object, from responses to banners from each user in a group of users;
electronically maintaining at least one first database of the list of banners, with the banners of the list of banners correlated into pairs;
obtaining data from at least one cookie from the browser of at least one user, for at least one response to at least one banner;
electronically maintaining at least one second database of the response data from the at least one cookie; and,
serving at least one banner from at least one correlated pair of banners from the list of banners in the at least one first database to the data object being browsed by at least one user, in accordance with the data in the at least one second database.

33. The method of claim 32, wherein the data object includes a web page.

34. The method of claim 32, wherein the data object includes a web site.

35. The method of claim 32, wherein the at least one banner is served upon receiving data from the data object that it is being browsed.

36. The method of claim 35, wherein the data includes a request for at least one banner and at the least one cookie.

37. The method of claim 32, wherein the data object being browsed is hosted by a server type device that is part of a publisher network.

38. The method of claim 37, wherein the at least one banner served is associated with a target web site hosted by a server type device that is part of an advertiser network.

39. The method of claim 32, wherein the at least one response to at least one banner includes at least one of an activation of the at least one banner or a non-activation of the at least one banner.

40. The method of claim 32, wherein the responses to banners from each user in a group of users include activations of the banners.

41. The method of claim 32, additionally comprising:
serving at the least one cookie with the banner to obtain data about the at least one user when the at least one user is browsing the data object.

42. The method of claim 32, wherein the group of users includes at least one user.

43. The method of claim 32, wherein the group of users includes multiple users.

44. The method of claim 32, wherein the at least one user includes an individual user.
